(19) United States
(12) Patent Application Publication
(10) Pub. No.: US 2007/0145210 A1
(43) Pub. Date: Jun. 28, 2007

(54) Noose lanyard with self-orienting mounting area

(76) Inventors: Christopher J. Fawcett, Charlotte, NC (US); Ronald M. Marsilio, Lake Wiley, SC (US); Dennis D. Belden, Canton, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/454,513

(22) Filed: Jun. 16, 2006

Related U.S. Application Data
(63) Continuation-in-part of application No. 11/431,291, filed on May 10, 2006.
(60) Provisional application No. 60/754,138, filed on Dec. 27, 2005.

(51) Int. Cl. F16M 11/00

(52) U.S. Cl. 248/176.1

(57) ABSTRACT

A display assembly for automatically orienting a display item includes a base, a mounting member and a lanyard which extends outwardly from the mounting member to loop around the display item. The mounting member is removably mounted on the base to allow handling of the display item when removed and when mounted automatically moves from an unaligned orientation to an aligned display orientation. A lanyard securing mechanism mounted on the mounting member includes an operating member for operating the securing mechanism. The lanyard and display item are movable relative to the mounting member from an operating-member access position for securing the lanyard via the operating member to an operating-member blocking position to block access to the operating member to prevent loosening of the lanyard via the operating member. An alarm is activated in response to compromise of the lanyard or removal of the display item from the blocking position.

### CROSS REFERENCE TO RELATED APPLICATIONS

This application is a continuation-in-part of U.S. patent application Ser. No. 11/431,291 filed May 10, 2006, which claims priority from U.S. Provisional Application Serial Member 60/754,138 filed Dec. 27, 2005; the disclosures of which are incorporated herein by reference.

### BACKGROUND OF THE INVENTION

1. Technical Field

The invention relates generally to display stands for merchandise. More particularly, the invention relates to a display stand which allows the handling of an item of merchandise. Specifically, the invention relates to such a display stand which orients the item of merchandise to a desired display orientation after the handling thereof.

2. Background Information

Amongst the great variety of display structures used to display items of merchandise are those which allow a potential customer to handle and view the item of merchandise in order to determine if it has characteristics desirable to the potential customer. This is commonly the case for displaying various types of electronic articles such as cell phones, cameras and the like which have a reasonably high unit value but which a retailer desires to allow the potential customer to handle without seeking a store employee simply to unlock the merchandise for such viewing and handling. In addition to the need to provide security against theft of such items, there is also a need to display the items of merchandise in an orderly manner. This often becomes a problem when a potential customer picks up an item of merchandise such as a cell phone or camera in order to look it over and see how it feels, and then places the item generally in the display area from which it was obtained but in a haphazard manner. Especially because multiple items of such merchandise are displayed near one another, when they are all replaced haphazardly, it creates quite a disorderly appearance. The present invention addresses this and other problems.

### BRIEF SUMMARY OF THE INVENTION

The present invention provides a security device comprising: a mounting member; a lanyard which is connected to and extends outwardly from the mounting member to form a closed loop defining a display item receiving space adapted to receive a display item so that the lanyard secures the display item to the mounting member; a lanyard securing mechanism which is mounted on the mounting member and includes an operating member for operating the securing mechanism; wherein the lanyard is movable relative to the mounting member from an operating-member access position adapted to allow access to the operating member when the display item is disposed in the receiving space to an operating-member blocking position adapted to block access to the operating member when the display item is disposed in the receiving space.

The present invention also provides a method comprising the steps of looping a lanyard which is connected to a mounting member around a portion of a display item; securing the display item to the mounting member in a first position with the lanyard and a lanyard securing mechanism; moving the display item while the display item is secured to the mounting member via the lanyard from the first position to a second position to block access to an operating member which operates the lanyard securing mechanism.

### BRIEF DESCRIPTION OF THE SEVERAL VIEWS OF THE DRAWINGS

FIG. 1 is a perspective view of a first embodiment of the base of the display device of the present invention.

FIG. 2 is a side elevational view of the first embodiment of the display device.

FIG. 3 is a fragmentary exploded view with portions in section showing the mounting member with an item of merchandise mounted thereon and removed from the base.

FIG. 4 is similar to FIG. 3 and shows the mounting member seated on the base.

FIG. 5 is a top plan view with portions cut away showing the mounting member and item of merchandise in dot dashed lines seated on the base in the unaligned orientation.

FIG. 6 is similar to FIG. 5 and shows the mounting member and article of merchandise rotating away from the position shown in FIG. 5 toward the aligned display orientation.

FIG. 7 is similar to FIG. 6 and shows the mounting member and item of merchandise in the aligned display orientation.

FIG. 8 is a fragmentary side elevational view with portions in section showing the mounting member and item of merchandise having rotated to the aligned display orientation.

FIG. 9 is a perspective view of a second embodiment of the display device of the present invention showing the mounting member mounted on the base.

FIG. 10 is a side elevational view of the display device shown in FIG. 9.

FIG. 11 is a fragmentary perspective view of the second embodiment showing the mounting member removed from the base.

FIG. 12 is a side elevational view of the second embodiment with portions cut away to show a sectional view of portions of the base which form the opening therein, the mounting member with an article of merchandise mounted thereon with the post of the mounting member disposed above the opening in the base.

FIG. 13 is similar to FIG. 12 and shows the mounting member and article of merchandise having moved downwardly so that the post is disposed in the opening of the base and making initial contact with the angled camming wall of the base which bounds the opening.

FIG. 14 is similar to FIG. 13 and shows the mounting member and article of merchandise rotating as they continue to move downwardly within the opening of the base.

FIG. 15 is similar to FIG. 14 and shows the mounting member and article of merchandise having fully rotated and moved downwardly to the aligned display orientation.

FIG. 16 is a side elevational view of a third embodiment of the stand of the present invention showing the mounting member and the upper portion of the base.

FIG. 17 is a top plan view of the mounting member of the third embodiment.

FIG. 18 is similar to FIG. 17 and shows the mounting member with the cover removed.

FIG. 19 is a sectional view taken on line 19-19 of FIG. 17.

FIG. 20 is a top plan view similar to FIG. 18 with a display item mounted on the mounting member via the lanyard.

FIG. 21 is a sectional view similar to FIG. 19 showing the display item attached as in FIG. 20.

FIG. 22 is a view similar to FIG. 21 showing the display item pivoting out of the position shown in FIG. 21.

FIG. 23 is similar to FIG. 22 and shows the display item pivoted from the position in FIG. 22 and adhered to the mounting member via an adhesive.

Similar numbers refer to similar parts throughout the drawings.

### DETAILED DESCRIPTION OF THE INVENTION

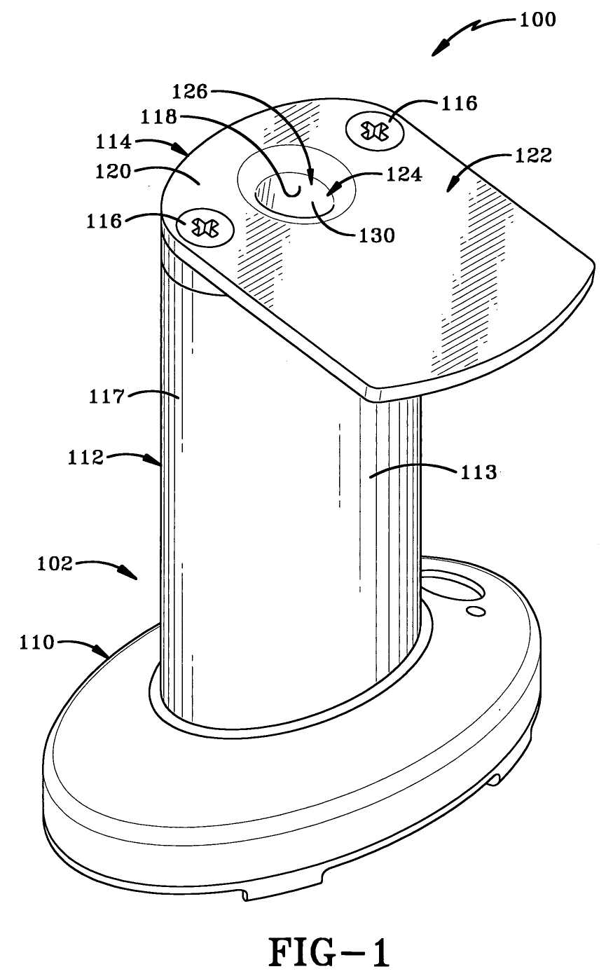

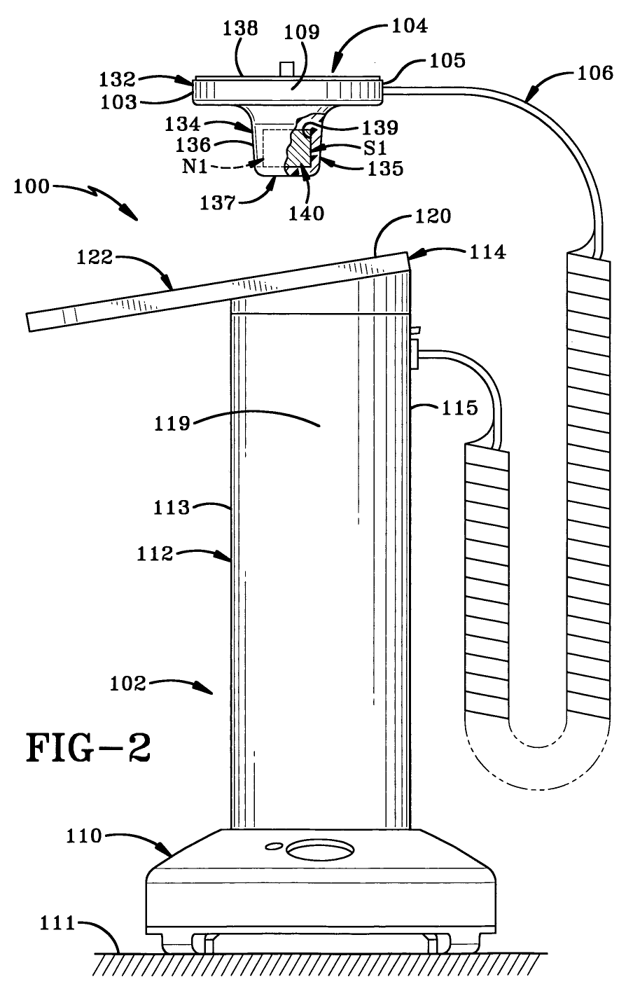

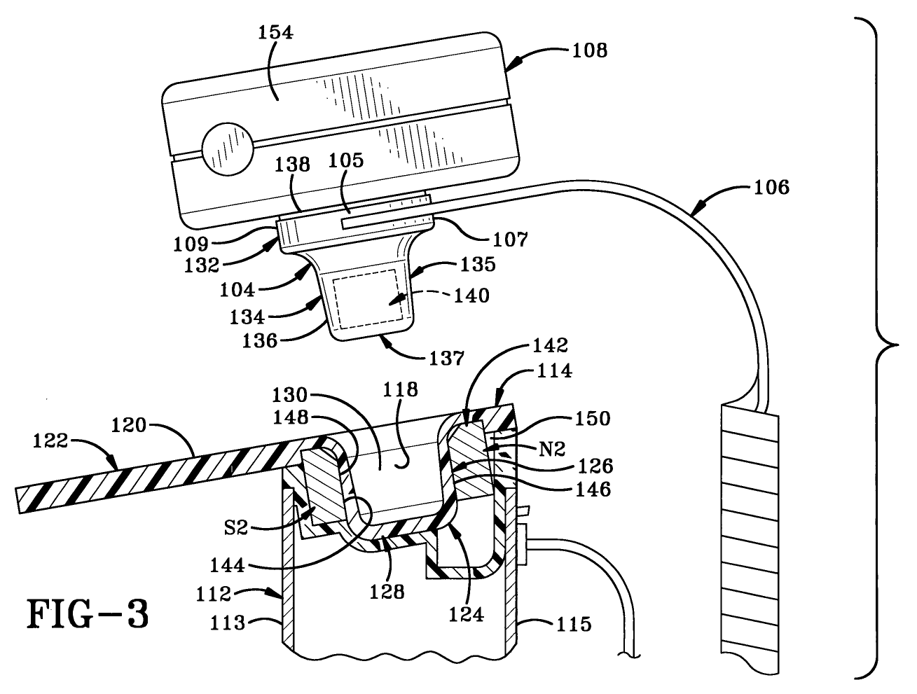

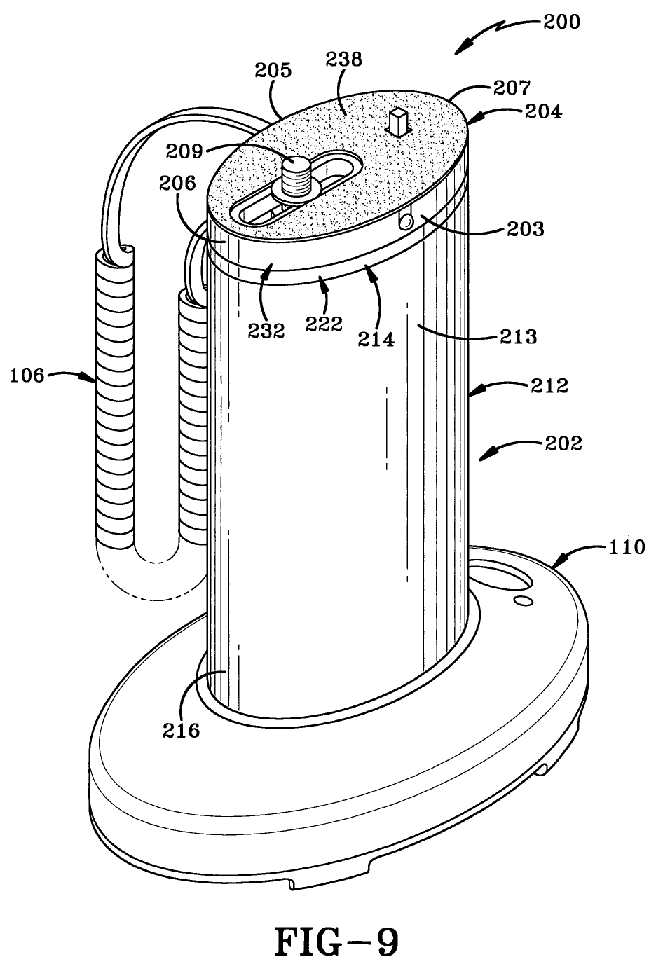

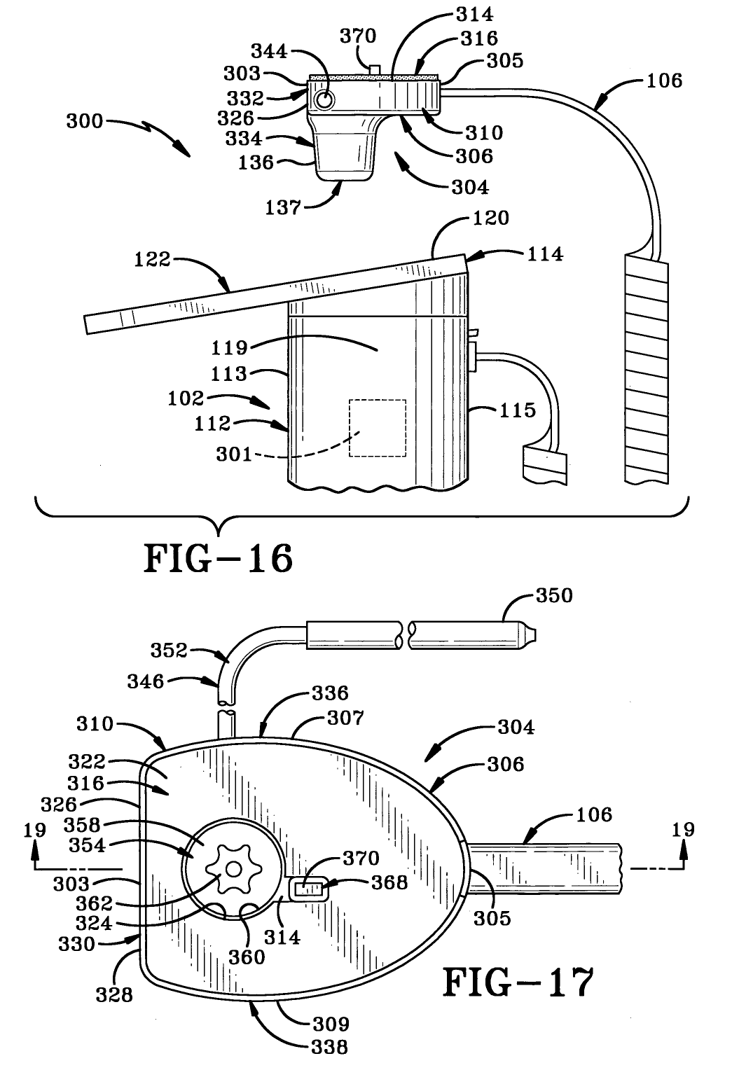

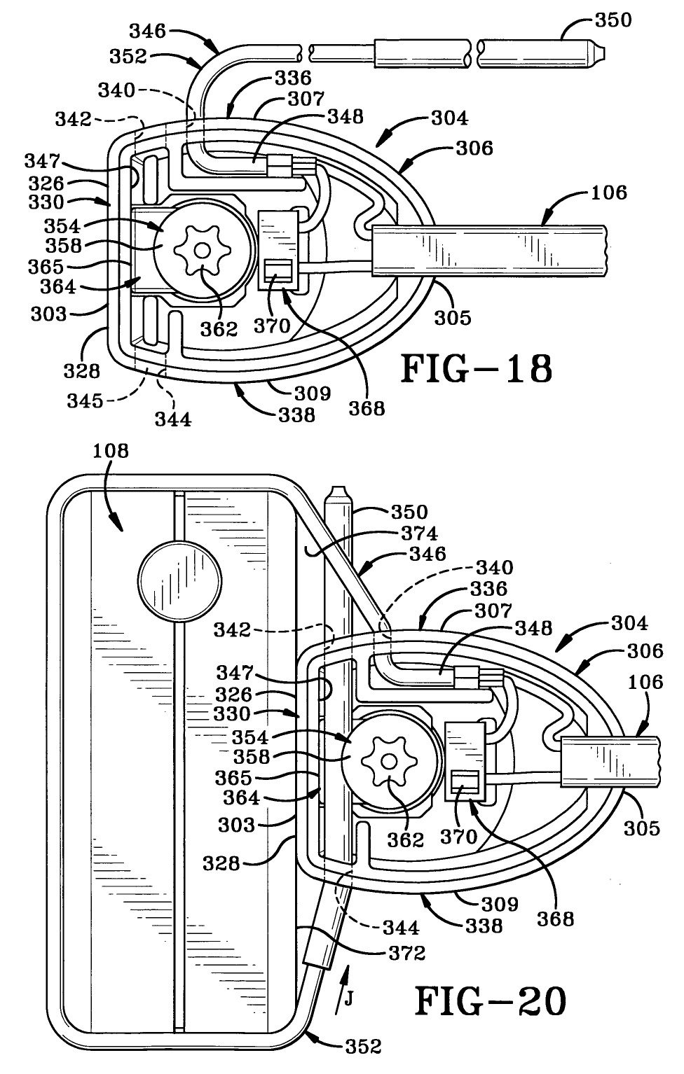

A first embodiment of the display assembly or display stand of the present invention is indicated generally at 100 in FIGS. 1-2; a second embodiment is indicated generally at 200 in FIGS. 9-11; and a third embodiment is indicated generally at 300 in FIGS. 16-17. Referring to FIGS. 1-2, stand 100 includes a base 102, a mounting member 104 which is removably mountable on base 102 and a tether 106 which is connected to and extends between base 102 and mounting member 104. Mounting member 104 has a front 103, an opposed rear 105 and first and second sides 107 and 109, which are noted herein primarily as points of reference to clarify the movement of mounting member 104 as later detailed. Mounting member 104 is configured for mounting thereon an item of merchandise or display item such as cell phone 108 (FIG. 3) in order to allow the item of merchandise to be moved away from base 102 in order to view and handle said item. Base 102 includes a foundation 110 which is seated on a support surface 111, an upwardly projecting column 112 which extends upwardly from foundation 110 and a seating member 114 which is connected to a top end of column 112 via a pair of fasteners in the form of screws 116. Column 112 has a front, an opposed rear 115 and first and second opposed sides 117 and 119, which are also noted herein primarily as points of reference to clarify the movement of mounting member 104 as detailed below.

Seating member 114 defines an opening 118 which extends downwardly from an upper surface 120 of seating member 114. More particularly, seating member 114 includes a substantially flat seating plate 122 and a cup-shaped member 124. Cup-shaped member 124 includes a cylindrical side wall 126 which extends downwardly from plate 122 and a bottom wall 128 (FIG. 3) connected to side wall 126 from which side wall 126 extends upwardly. Cup-shaped member 124 has a smooth inner surface 130.

Mounting member 104 includes a merchandise mounting portion 132 and a base mounting portion in the form of a post 134 which extends downwardly from portion 132. Post 134 includes a cylindrical or frustoconical side wall 135 extending downwardly from mounting portion 132 and a bottom wall 137 connected to side wall 135 such that side wall 135 and bottom wall 137 define therein an interior chamber 139. Sidewall 135 has a generally frustoconical or cylindrical outer surface 136 of a mating configuration with inner surface 130 of cup-shaped member 124. Outer surface 136 is smooth so that friction between surface 136 and surface 130 is reduced to facilitate slidable engagement therebetween when post 134 is disposed in opening 118. Mounting portion 132 has an upper surface 138 on which cell phone 108 is mountable.

In accordance with a feature of the invention, a first magnet 140 is disposed within interior chamber 139 of post 134 and a second magnet 142 (FIG. 3) is mounted on base 102 adjacent and external to cup-shaped member 124. First magnet 140 has a north pole N1 and a south pole S1. Second magnet 142 is a ring magnet which defines a central magnet opening 144 in which side wall 126 of cup-shaped member 124 is disposed with an outer surface 146 of side wall 126 abutting an inner surface 148 of magnet 142. Magnet 142 is mounted within an interior chamber 150 defined by column 112 adjacent an upper end thereof. Second magnet 142 has a north pole N2 and a south pole S2 which magnetically attract respectively south pole S1 and north pole N1 of first magnet 140 to align mounting member 104 and cell phone 108 when mounted thereon in an aligned display orientation when post 134 is disposed within opening 118 of base 102. In addition, repelling forces are also provided between south poles S1 and S2 and between north poles N1 and N2 which assist in the rotation of mounting member 104 and cell phone 108 to the aligned display orientation.

Tether 106 is preferably of a configuration which allows for extension and retraction thereof, such as a coiled wire, here shown as a standard telephone cord. Tether 106 may thus also provide electrical communication between base 102 and mounting member 104 to, for example, provide a security alarm should cell phone 108 be removed from mounting member 104 or should the electrical connection provided by tether 106 be compromised in some fashion. Base 102 may be free standing although it is generally preferable that base 102 be secured to support surface 111.

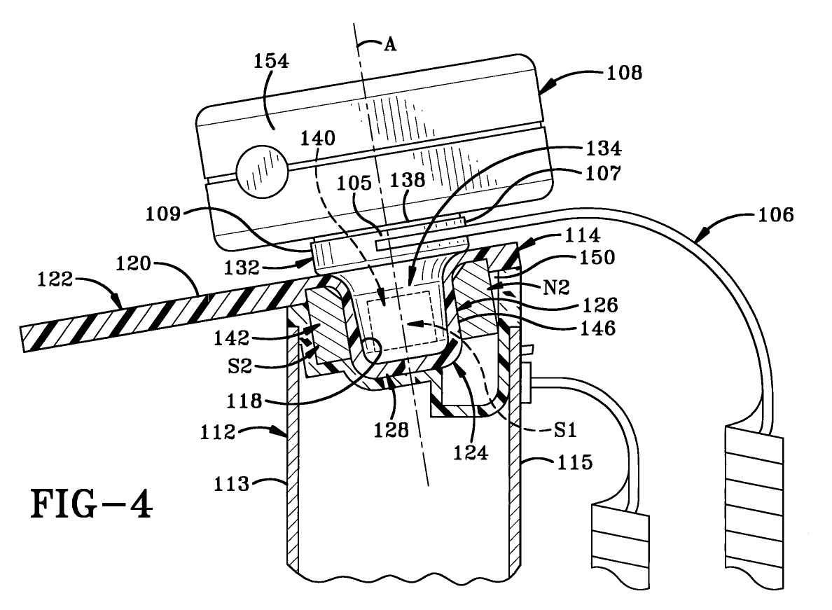

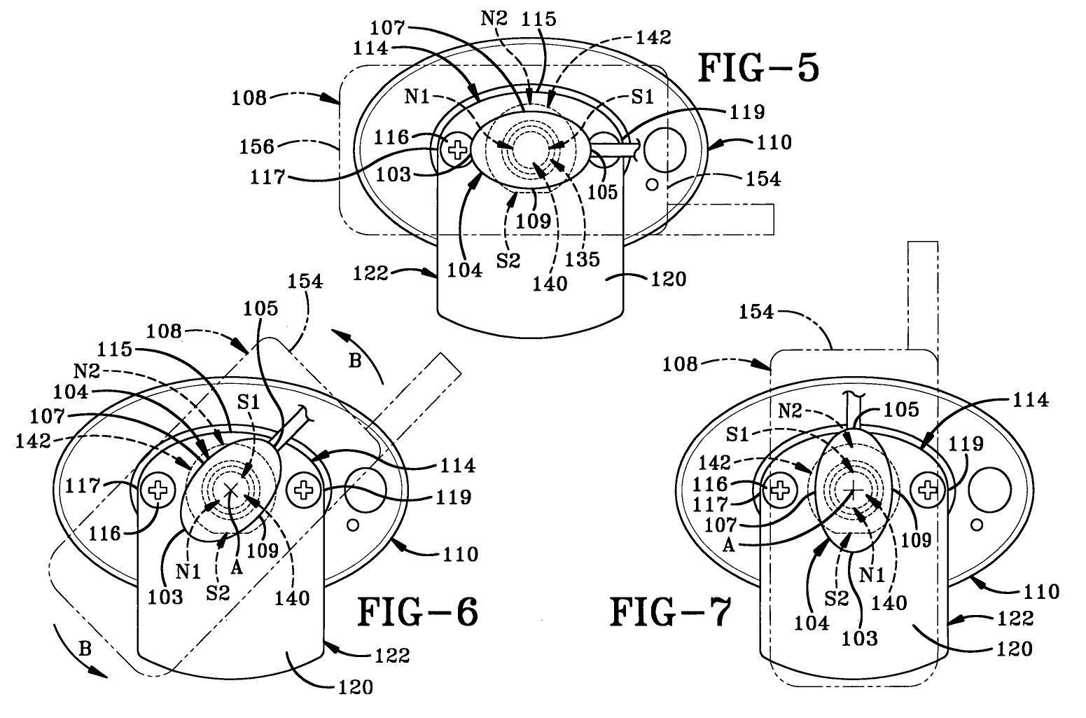

The operation of display stand 100 is described with reference to FIGS. 4-8. FIG. 4 shows mounting member 104 mounted on base 102 with post 104 disposed in opening 118 in an unaligned orientation. More particularly, north and south poles N1 and S1 of first magnet 140 are not respectively aligned with south and north poles S2 and N2 of second magnet 142. As shown in FIG. 4, south pole S1 of first magnet 140 is generally offset approximately 90° from north pole N2 of second magnet 142. As seen in FIG. 4, rear 105 of member 104 is generally aligned with south pole S1 of first magnet 140 and is thus approximately 90° offset from either of north pole N2 and south pole S2 of magnet 142. In addition, a top 154 and bottom 156 of cell phone 108 provide reference points. FIG. 4 shows top 154 also generally aligned with rear 105 of member 104 and south pole S1 of first magnet 140. FIG. 5 shows mounting member 104 and cell phone 108 from above in the unaligned orientation as shown in FIG. 4.

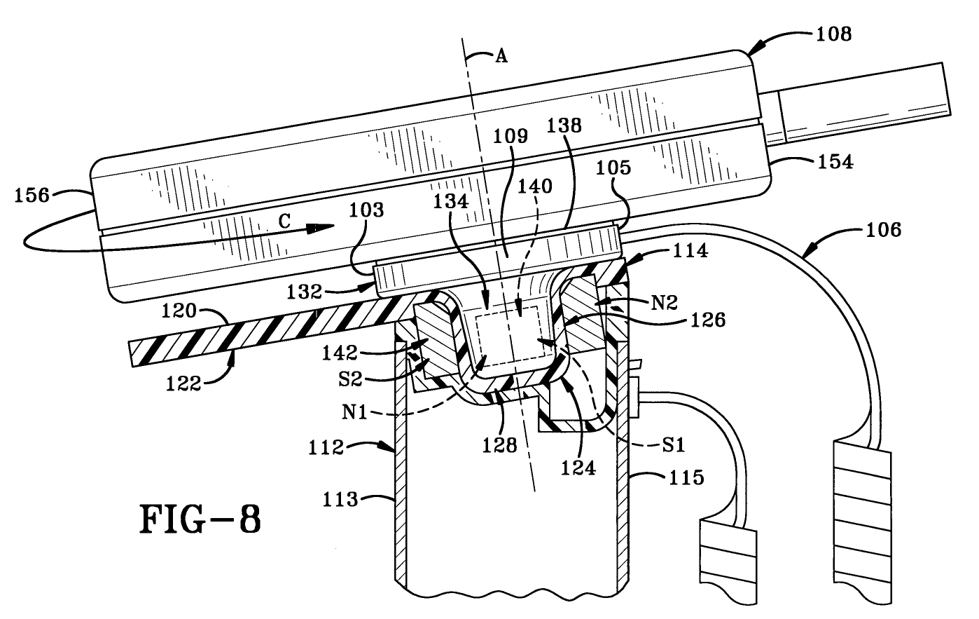

FIG. 6 shows rotation of mounting member 104 and cell phone 108 (Arrows B) about an axis A which passes centrally through post 134. Said rotation is in response to the magnetic attraction between respective north and south poles N1 and S1 of first magnet 140 and south and north poles S2 and N2 of second magnet 142 and repulsion between like poles. FIG. 7 shows mounting member 104 and cell phone 108 having been rotated completely to the aligned display orientation. FIG. 8 shows mounting member 104 and cell phone 108 having rotated as indicated at Arrow C to the aligned display orientation so that north and south poles N1 and S1 of first magnet 140 are respectively aligned with south and north poles S2 and N2 of second magnet 142. This rotational movement of mounting member 104 and phone 108 occurs automatically simply by releasing mounting member 104 with post 134 in opening 118 without any additional force necessary beyond the magnetic attraction and repulsion described above. While it is possible to provide a magnetic field via the use of an electric current, it is preferred to utilize permanent magnets such as magnets 140 and 142 to provide a simple and cost efficient magnetically operable alignment mechanism.

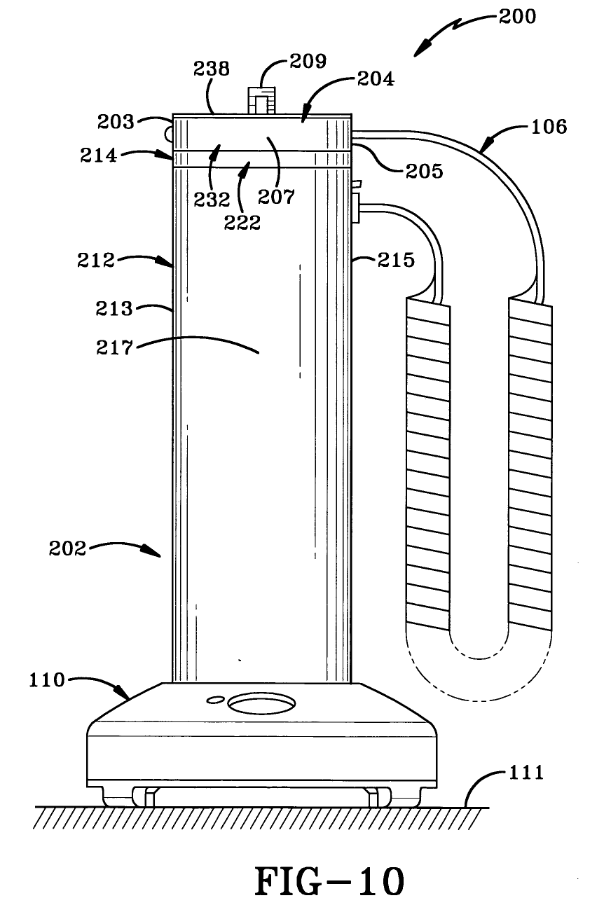

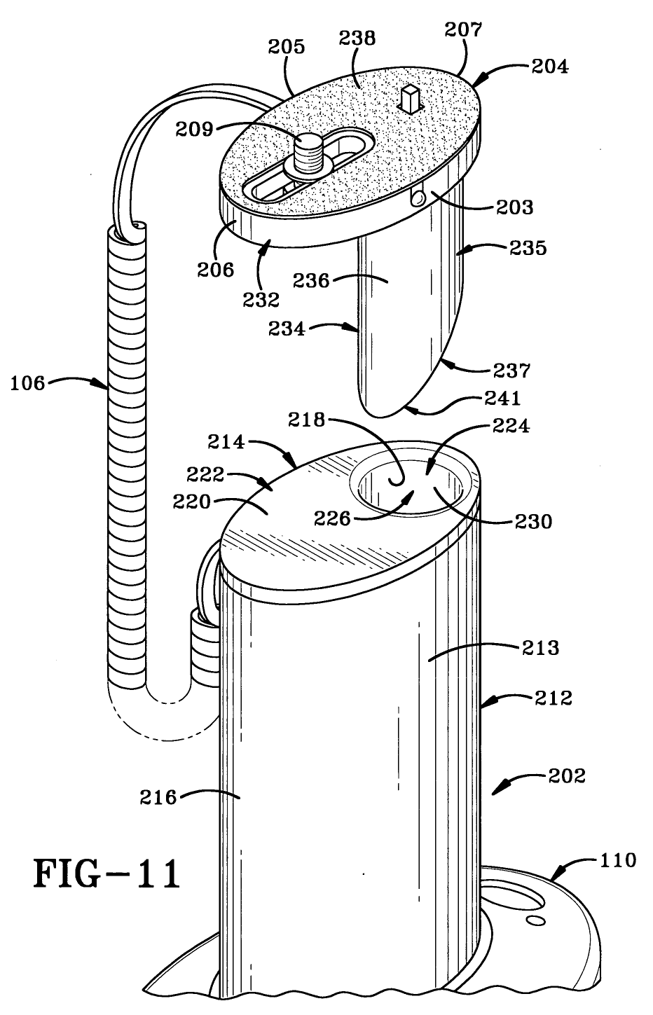

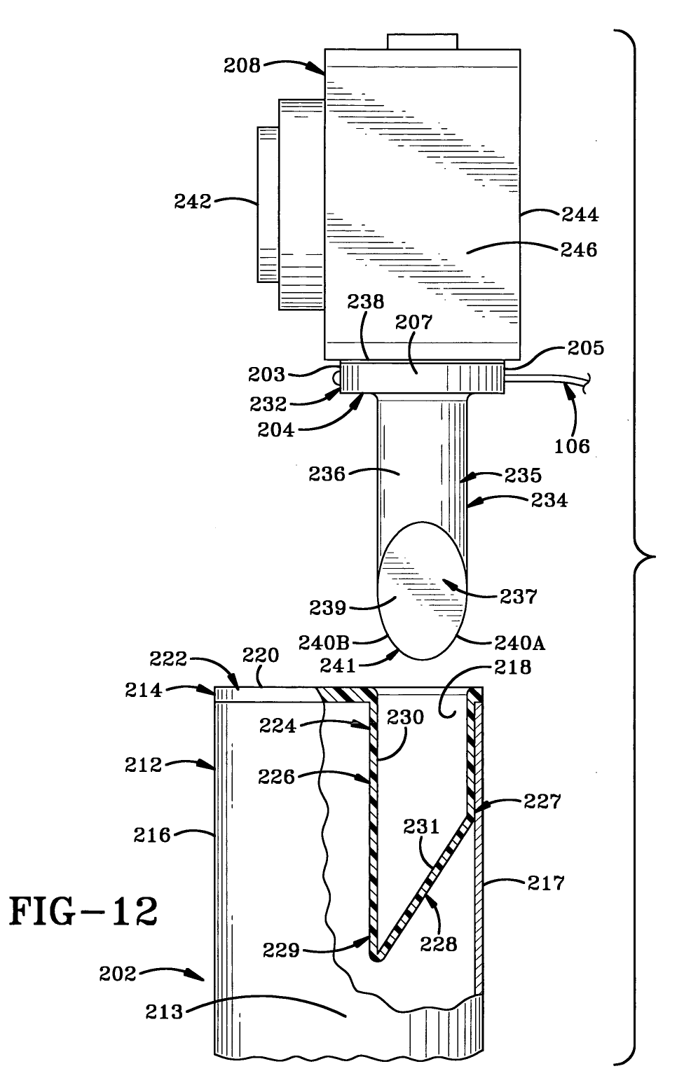

Referring to FIGS. 9-10, display stand 200 is now described. Display stand 200 is similar to stand 100 in that it includes a base 202, a mounting member 204 and tether 106. Mounting member 204 is configured for mounting thereon an item of merchandise in the form of a camera 208 (FIG. 12) via a fastener 209 such as a screw or a bolt shown here extending through an elongated opening formed in mounting member 204. Any suitable mounting mechanism known in the art may be used for mounting an item of merchandise to mounting member 204. Mounting member 204 has a front 203, a rear 205 opposed thereto and first and second opposed sides 206 and 207. Base 202 is similar to base 102 in that it includes a foundation 110 and a column 212 which is similar to column 112. Column 212 has a front 213, a rear 215 opposed thereto and first and second opposed sides 216 (FIG. 11) and 217. Base 202 further includes a seating member 214 which is mounted atop column 212 via adhesive, sonic welding or any other suitable means known in the art.

With reference to FIGS. 11-12, seating member 214 defines an opening 218 which extends downwardly from an upper surface 220 of member 214. More particularly, seating member 214 includes a seating plate 222 which defines flat upper surface 220. Member 214 further includes a cup-shaped member 224 extending downwardly from plate 222 in the form of a truncated cylinder. More particularly, member 224 includes a substantially cylindrical side wall 226 extending downwardly from plate 222 and an angled bottom wall 228 which in particular angles downwardly from a first side 227 of side wall 226 to a second opposed side 229 of side wall 226. Bottom wall 228 is substantially flat and has an oval shape. Cup-shaped member 224 has an inner surface 230 which is preferably smooth to promote slidable engagement with minimal friction between surface 230 and post 234. Inner surface 230 includes an inner or upper surface 231 of bottom wall 228. Upper surface 231 is substantially flat, angles downwardly from adjacent first side 227 to adjacent second side 229 of side wall 226 and is substantially oval in shape. Opening 218 is thus an interior chamber bounded by inner surface 230 of side wall 226 and bottom wall 228.

Mounting member 204 includes a merchandise mounting portion 232 having an upper surface 238 and a base mounting portion in the form of a post 234 which is connected to and extends downwardly from portion 232. Post 234 includes a substantially cylindrical side wall 235 having a substantially cylindrical and thus convex outer surface 236 which is smooth to promote easy sliding engagement with inner surface 230 of cup-shaped member 224. Post 234 further includes a substantially flat oval-shaped bottom wall 237 having a lower surface 239 which angles in a mating configuration with upper surface 231 of bottom wall 228 of cup-shaped member 224. Bottom wall 237 has an oval-shaped outer perimeter 241 lying along outer surface 236 of sidewall 235. Post 234 adjacent its lower end has first and second arcuate camming surfaces 240A and 240B which are located on perimeter 241 at the intersection of side wall 235 and bottom wall 237. Camming surfaces 240A and 240B alternately work in conjunction with upper surface 231 of bottom wall 228 in order to rotate mounting member 204 and camera 208 to the aligned displayed orientation as discussed further below. Each camming surface 240 is an arcuate surface which runs along the lower end of side wall 235. Each camming surface 240 is an arc of the oval outer perimeter 241 formed by the truncation of cylindrical side wall 235.

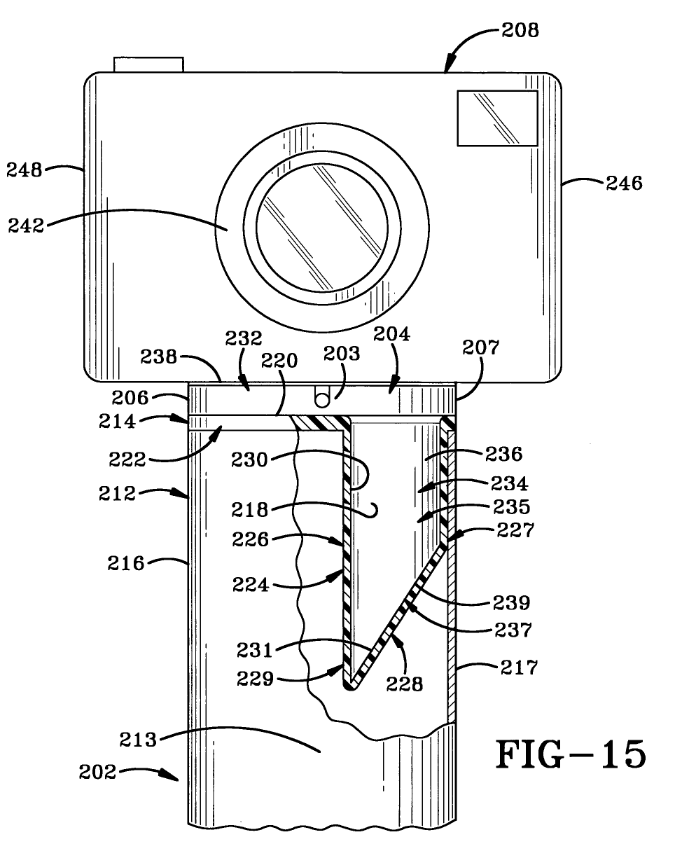

Operation of display stand 200 is described with reference to FIGS. 12-15. FIG. 12 shows mounting member 204 in the removed position with camera 208 mounted thereon. A front 242, rear 244 and opposed sides 246 and 248 (FIG. 15) of camera 208 may be used as reference points to clarify movement of mounting member 204 and camera 208 to an aligned display orientation.

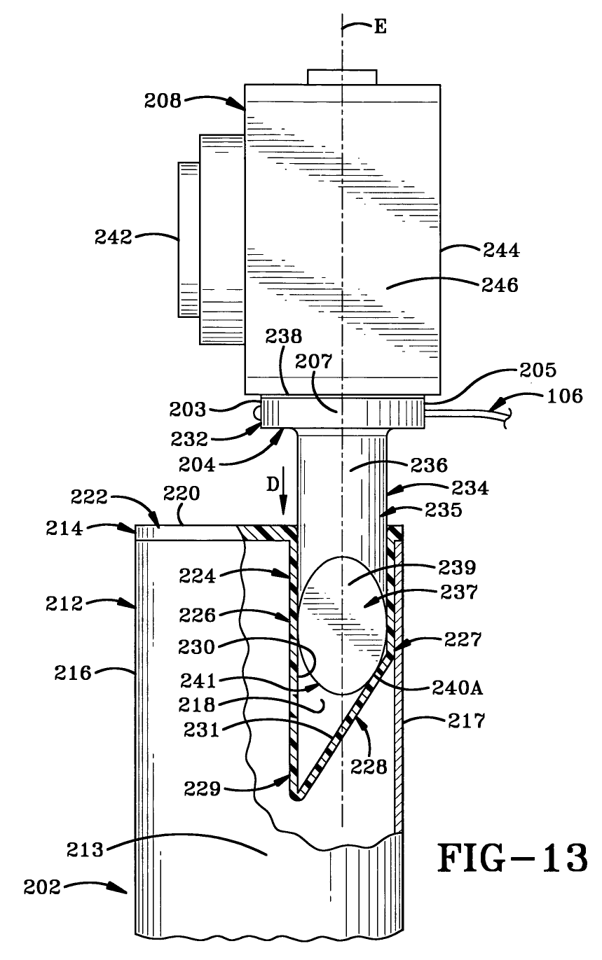

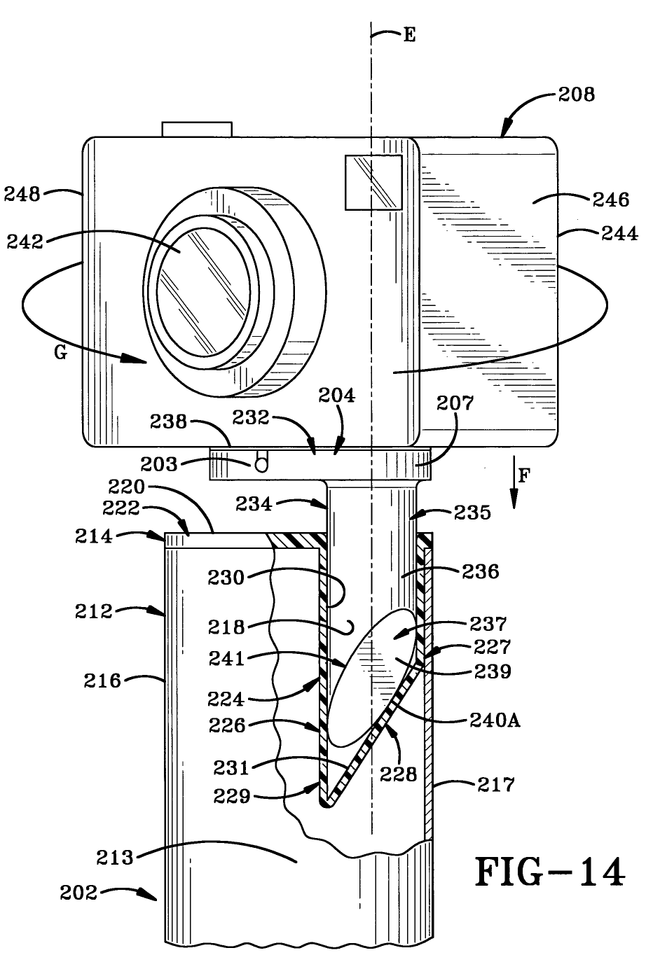

FIG. 12 shows mounting member 204 with front 203 thereof facing toward first side 216 of column 212 and front 242 of camera 208 facing likewise. The user or potential customer returns mounting member 204 to its mounted position on base 202 with post 234 disposed in opening 218 by moving mounting member 204 and camera 208 downwardly as indicated at arrow D in FIG. 13. In the exemplary embodiment, this downward movement is linear parallel to a substantially vertical axis E which passes through the center of the post 234. FIG. 13 shows camming surface 240A at an initial point of engagement with upper surface 231 of bottom wall 228. Once post 234 is inserted within opening 218, the person handling camera 208 may simply release camera 208 and mounting member 204 and the force of gravity will pull member 204 and camera 208 further downwardly as indicated at arrow F in FIG. 14 as the camming engagement between camming surfaces 240A and 231 causes member 204 and camera 208 to rotate about axis E as indicated at arrow G whereby front 242 of camera 208 and front 203 of mounting member 204 move toward front 213 of column 212.

The combination of the downward movement and the rotational movement about axis E produces downwardly spiraling movement of member 204 and camera 208. During this movement, camming surface 240A slides downwardly and laterally along the angled inner surface 231 while outer surface 236 of side wall 235 of post 234 slidably engages inner surface 230 along side wall 226 of cup shaped member 224. Prior to the engagement of camming surface 240A and inner surface 231, this slidable engagement between surfaces 236 and 230 may simply be vertically downward in a linear fashion. Once camming surfaces 240 and 231 engage and cause the rotation of member 204 and camera 208, the sliding engagement between surfaces 236 and 230 includes the rotational movement and thus will also involve a downwardly spiraling slidable engagement therebetween. This downward spiraling movement continues until lower surface 239 of post 234 is seated in a mating fashion on upper surface 231 of mounting wall 228 at which time front 242 of camera 208 and front 203 of mounting member 204 are aligned with front 213 of column 212 and the associated rear portions and sides of these members are also respectively aligned. Thus, gravitational force moves member 204 and camera 208 downwardly and causes rotation via camming surfaces 240A and 231 to achieve the aligned display orientation of FIG. 15. No other force is required to achieve the display orientation which occurs automatically upon the release of camera 208 and member 204 with post 234 disposed within opening 218 of base 202.

Alternately, camming surface 240B may engage camming surface 231 to rotate member 204 and camera 208 about axis E in the opposite direction indicated by arrow G in FIG. 14. Display stand 200 thus provides a simple alignment mechanism for moving mounting member 204 and merchandise such as camera 208 from an unaligned orientation to an aligned display orientation as described.

Referring to FIGS. 16-19, stand 300 is now described. Display stand 300 is similar to stand 100 in that it includes a base 102, a mounting member 304 and a tether 106. Base 102 includes an alarm 301 (FIG. 16), which may include an audible alarm and/or a visible alarm light. Mounting member 304 is the distinguishing feature of stand 300 although it has some similar characteristics to mounting members 104 and 204. Mounting member 304 has a front 303, opposed rear 305 and first and second sides 307 and 309, which as with the earlier embodiments are primarily noted as points of reference for clarifying the movement of mounting member 304. In short, mounting member 304 moves in the same fashion as mounting member 104 via the interaction of magnets 140 and 142 when mounting member 304 is mounted on base 102.

Mounting member 304 includes a merchandise mounting portion 332 and a base mounting portion in the form of a post 334 which extends downwardly from mounting portion 332. Post 334 is similar in many regards to post 134 of mounting member 104 so that the similar aspects are similarly membered and not further discussed hereafter.

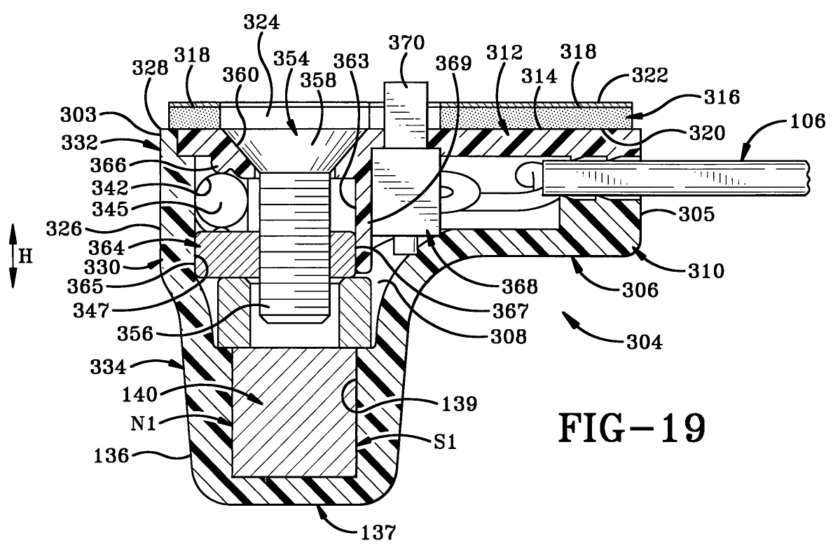

Mounting member 304 includes a housing 306 which includes mounting portion 332 and post 334. Housing 306 defines an interior chamber 308 (FIG. 19) which includes interior chamber 139 of post 334. Housing 306 includes a generally hollow base member 310 which primarily defines interior chamber 308 and a cover 312 (FIG. 19) which is connected to base member 310 and bounds the upper portion of interior chamber 308. Cover 312 has a flat upper surface 314 to which is connected an adhesive member 316 having an adhesive upper surface 318 and a lower surface 320 which is typically also made up of an adhesive layer. Adhesive member 316 typically includes a thin layer of foam or the like with the adhesive layers along upper surface 318 and lower surface 320. A peel strip 322 is removably connected to member 316 along upper surface 318. Adhesive member 316 defines a through opening 324 (FIGS. 17 and 19) which is disposed directly above post 334. Base member 310 includes a flat front surface 326 which extends transversely downwardly from upper surface 314 of cover 312 and intersects upper surface 312 at a linear intersection 328. Front surface 326 is typically substantially perpendicular to upper surface 314. Base member 310 includes a flat front wall 330 which defines front surface 326 and a pair of spaced arcuate side walls 336 and 338 which are connected to an extend rearwardly from front wall 330. Side walls 336 and 338 curve toward one another to meet at rear 305 of mounting member 304. First side wall 336 defines first and second spaced through holes 340 and 342, the latter being adjacent front wall 330. Second side wall 338 defines a third through hole 344 which is adjacent front wall 330 and aligned with hole 342. Holes 342 and 344 communicate with interior chamber 308 to form a through passage 345 (FIGS. 18-19) along an inner surface 347 of front wall 330.

Mounting member 304 includes a mounting mechanism which includes a lanyard 346 for securing cell phone 108 to housing 306. Lanyard 346 has first and second ends 348 and 350 and extends through hole 340 adjacent first end 348 and includes a body 352 extending between first and second ends 348 and 350. Body 352 includes electrical conductors which are part of a sense loop and are in electrical communication with electrical conductors of tether 106, which are in electrical communication with alarm 301 (FIG. 16). Body 352 of lanyard 346 includes a larger diameter portion adjacent end 350. Lanyard 346 is movable between an open-loop position (FIGS. 17-18) and a closed-loop position (FIG. 20) in which the portion adjacent end 350 of lanyard 346 is inserted within passage 345 via hole 344. Hole 342 is provided so that any excess of lanyard 346 may extend outwardly therefrom when lanyard 346 is in the closed-loop position.

Referring to FIG. 19, the mounting mechanism of mounting member 304 further includes an operating member in the form of a securing screw 354 which has a threaded portion 356 disposed within interior chamber 308 and a head 358 which is matingly received within a countersunk hole 360 formed in cover 312. Head 358 and hole 360 are aligned directly below opening 324 of adhesive member 316 so that head 358 is accessible via opening 324. Head 358 includes a tool-engaging portion 362 (FIGS. 17, 18, 20) which is engageable by a star wrench, hex wrench, screwdriver or other tool in order to rotate screw 354. An internally threaded nut 364 is disposed within interior chamber 308 and threadably engages portion 356 of screw 352 so that nut 364 is movable upwardly and downwardly (Arrow H) in response to rotation of screw 354 respectively in opposite directions. Nut 364 adjacent wall 330 is disposed directly below passage 364 and serves as a clamping member for clamping lanyard 346 against a clamping portion 366 of cover 312, clamping portion 366 being disposed directly above passage 345. Nut 364 is prevented from rotating by engagement of flats thereof with flat surfaces of housing 306. More particularly, flat inner surface 347 of front wall 330 engages one flat 365 of nut 364 and another flat surface 363 engages another flat 367 of nut 364 to prevent said rotation. The flats also slidably engage surfaces 347 and 363 to allow upward and downward movement of nut 364. Surface 363 is part of a downwardly extending projection 369 of cover 312. A plunger switch 368 is also disposed in interior chamber 308 and includes a plunger 370 which is movable between a depressed position and a non-depressed position in which plunger 370 extends above upper surface 318 of adhesive member 316. Plunger 370 is in electrical communication with alarm 301 (FIG. 16) via the electrical conductors of tether 16 and lanyard 346 (FIGS. 18, 20).

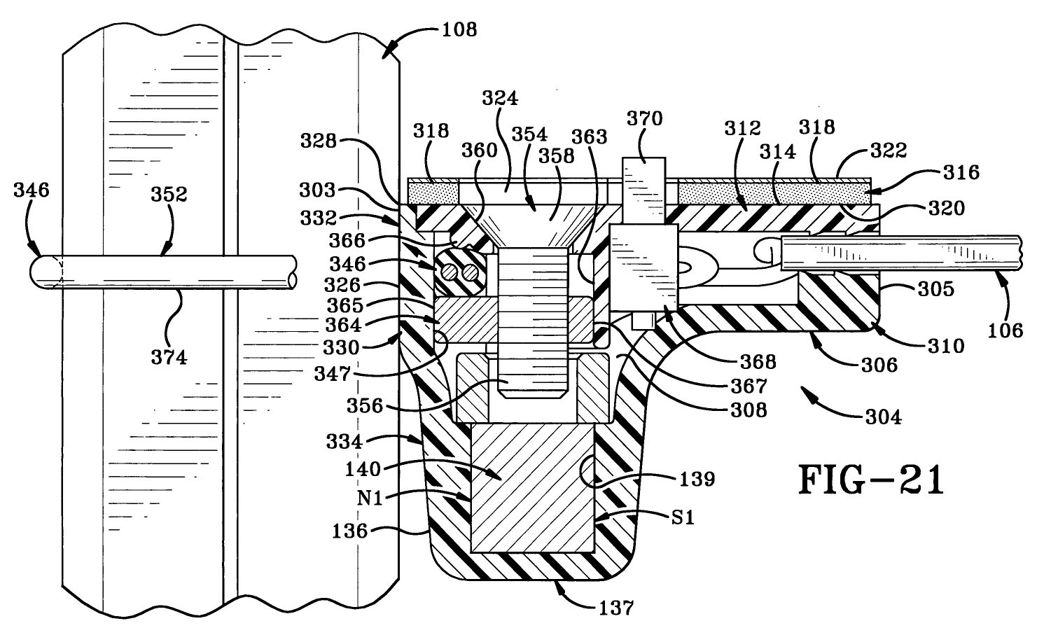

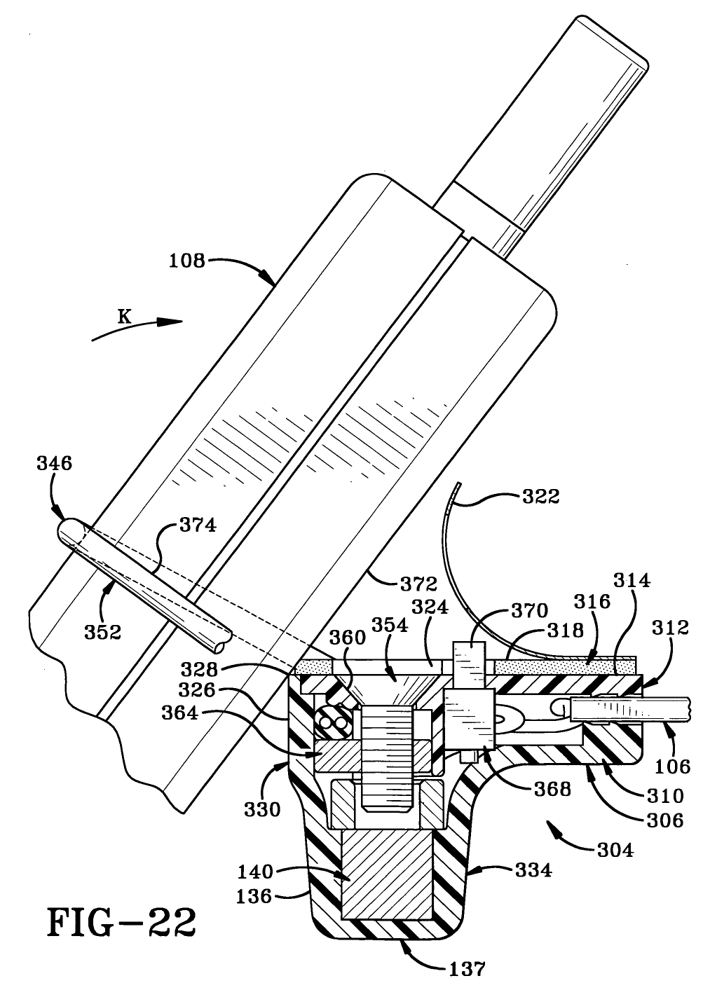

The operation of the mounting mechanism of mounting member 304 is now described with reference to FIGS. 20-23. The mounting mechanism is ultimately used to secure a display item such as cell phone 108 on upper surface 318 of adhesive member 316. Cell phone 108 has a mounting surface 372 which happens to be the rear of cell phone 108, although other display items may have mounting surfaces which may be on the bottom of the item or otherwise. Cell phone 108 is positioned with mounting surface 372 facing front surface 326 of base member 310 and typically in contact therewith (FIGS. 20-21). Lanyard 346 is then looped around a portion of cell phone 108 and end 350 thereof inserted into passage 345 via opening 344 (Arrow J in FIG. 20) so that a portion of lanyard 346 is disposed directly between clamping portion 366 of cover 312 and nut 364. Screw 354 is then rotated to move nut 364 upwardly to clamp lanyard 346 against clamping portion 366 in order to secure lanyard 346 in the closed-loop position and secure cell phone 108 against front surface 326. In this position, lanyard 346 and housing 306 adjacent front surface 326 define there between a display item receiving space 374 in which a portion of cell phone 108 is disposed.

Referring to FIG. 22, peel strip 322 is removed from adhesive layer 318. Then, cell phone 108 and lanyard 346 are then moved pivotally relative to housing 306 so that phone 108 and lanyard 346 are pivoted about the portion of lanyard 346 which is disposed within passage 345 (Arrow K). During this pivotal movement, mounting surface 372 of phone 108 engages and pivots about intersection 328 and typically slides along intersection 328. Surface 372 of phone 108 may also slidably engage front surface 326 during a portion of this movement.

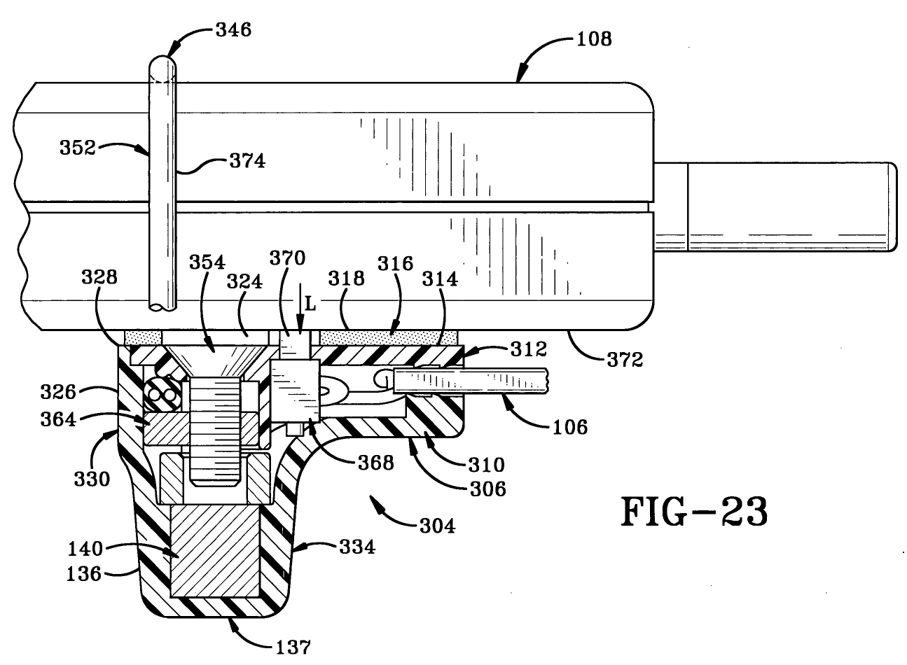

When the pivoting movement of cell phone 108 and lanyard 346 is completed (FIG. 23), surface 372 of phone 108 engages upper surface 318 of adhesive member 316 so that the adhesive layer adheres phone 108 to adhesive member 316 and thus prevents movement of phone 108 and 346 back to the original position abutting surface 326 or otherwise away from this adhered position. Indeed, the adhesion of phone 108 to surface 318 substantially fixes phone 108 with respect to housing 306. During the pivotal movement of phone 108, surface 372 thereof contacts and depresses plunger 370 (Arrow L) of plunger switch 368 in order to change the state of said switch and activate alarm 301 (FIG. 16) within base 102. Plunger switch 368 thus serves as a position sensor for sensing whether cell phone 108 is mounted on surface 318. Depression of plunger 370 arms alarm 301 and release of plunger 370 to the non-depressed position activates alarm 301.

It will be appreciated that cell phone 108 when abutting front surface 326 of housing 306 is in an operating-member access position (FIGS. 20-21) in which screw 354 is accessible both for the tightening and loosening thereof. Thus, the movement of phone 108 and lanyard 346 from the access position into the secured position on adhesive member 316 positions lanyard 346 and phone 108 in an operating-member blocking position (FIG. 23) to cover opening 324 and screw 354 to block access thereto so that screw 354 may not be rotated to loosen the clamping engagement provided by nut 364 on lanyard 346. Once cell phone 108 is secured on adhesive member 316, mounting member 304 may be used in the same fashion as mounting member 104 by inserting post 354 into opening 118 thereof whereby phone 108, lanyard 346 and mounting member 304 are automatically moved from an unaligned orientation to an aligned display orientation as has been previously described.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A security device comprising:
a mounting member;
a lanyard which is connected to and extends outwardly from the mounting member to form a closed loop defining a display item receiving space adapted to receive a display item so that the lanyard secures the display item to the mounting member;
a lanyard securing mechanism which is mounted on the mounting member and includes an operating member for operating the securing mechanism;
wherein the lanyard is movable relative to the mounting member from an operating-member access position adapted to allow access to the operating member when the display item is disposed in the receiving space to an operating-member blocking position adapted to block access to the operating member when the display item is disposed in the receiving space.

2. The device of claim 1 wherein the operating member includes a threaded portion; wherein the lanyard securing mechanism includes a threaded member which threadedly engages the threaded portion of the operating member; and wherein the operating member is alternately rotatable in first and second opposed directions to respectively secure and release the lanyard.

3. The device of claim 2 wherein the threaded member moves in a clamping direction for clamping the lanyard in response to rotation of the operating member in the first direction.

4. The device of claim 1 wherein the mounting member includes first and second clamping members; and wherein at least one of the clamping members is movable relative to the other between a clamped position for clamping the lanyard and an unclamped position for releasing the lanyard in response to movement of the operating member.

5. The device of claim 1 further including a retaining mechanism for securing the lanyard in the blocking position in a manner which prevents the lanyard from moving out of the blocking position.

6. The device of claim 1 wherein the mounting member includes an adhesive which is disposed adjacent the receiving space when the lanyard is in the blocking position and is adapted to secure the display item to the mounting member when the lanyard is in the blocking position.

7. The device of claim 1 further including a position sensor which is mounted on the mounting member and adapted to sense whether or not the display item is positioned to block access to the operating member.

8. The device of claim 7 wherein the position sensor includes a plunger which is movable between depressed and non-depressed positions and which extends outwardly from the mounting member when in the non-depressed position.

9. The device of claim 7 further including an alarm which is activated in response to a non-blocking signal from the position sensor whereby the alarm is adapted to be activated when the display item is not positioned to block access to the operating member.

10. The device of claim 1 further including an alarm which is activated in response to compromise of the lanyard.

11. The device of claim 1 wherein the lanyard is pivotally connected to the mounting member to pivot from the access position to the blocking position.

12. The device of claim 1 wherein the mounting member has first and second surfaces which extend transversely to one another; wherein the receiving space is bounded by the lanyard and the first surface when the lanyard is in the access position; and wherein the receiving space is bounded by the lanyard and the second surface when the lanyard is in the blocking position.

13. The device of claim 12 wherein the first and second surfaces are substantially flat.

14. The device of claim 12 in combination with the display item; wherein the first and second surfaces meet one another at an intersection; and wherein the display item pivotally engages the mounting member at the intersection during movement of the lanyard from the access position to the blocking position.

15. The device of claim 1 in combination with the display item; and wherein the display item blocks access to the operating member in the blocking position.

16. The device of claim 1 in combination with the display item; wherein the display item slidably engages the mounting member during movement of the lanyard from the access position to the blocking position.

17. The device of claim 1 in combination with the display item; wherein the mounting member has first and second surfaces which meet one another at an intersection; and wherein the display item pivotally engages the mounting member at the intersection during movement of the lanyard from the access position to the blocking position.

18. The device of claim 1 further including a base; wherein the mounting member is movable between a mounted position in which the mounting member is in contact with the base and a removed position in which the mounting member is movable so that the mounting member is adapted to facilitate viewing and handling of the display item.

19. The device of claim 18 wherein the mounting member when in the mounted position is movable between an unaligned orientation and an aligned display orientation; and further including an alignment mechanism for automatically moving the mounting member from the unaligned orientation to the display orientation.

20. A method comprising the steps of:
looping a lanyard which is connected to a mounting member around a portion of a display item;
securing the display item to the mounting member in a first position with the lanyard and a lanyard securing mechanism;
moving the display item while the display item is secured to the mounting member via the lanyard from the first position to a second position to block access to an operating member which operates the lanyard securing mechanism.
